(19) United States
(12) Patent Application Publication
(10) Pub. No.: US 2004/0149579 A1
(43) Pub. Date: Aug. 5, 2004

(54) System for monitoring combustible gases

(75) Inventors: Carl A. Palmer, Hudson, OH (US); Eric Weissman, Chagrin Falls, OH (US); Earl Goodsell, Hudson, OH (US); Dominic T. Flauto, Willoughby, OH (US); Jeff Parmelee, Cuyahoga Falls, OH (US); Donald A. Schneider, Lakewood, OH (US); Jeff Johanning, Hudson, OH (US)

Correspondence Address: NIXON & VANDERHYE P.C./G.E., 1100 N. GLEBE RD., SUITE 800, ARLINGTON, VA, 22201, US

(73) Assignee: General Electric Company, Schenectady, NY

(21) Appl. No.: 10/738,209

(22) Filed: Dec. 18, 2003

Related U.S. Application Data
(60) Provisional application No. 60/434,426, filed on Dec. 19, 2002.

(51) Int. Cl. G01N 27/26

(52) U.S. Cl. 204/431

(57) ABSTRACT

A method and apparatus for monitoring and measuring gas concentrations in combustor applications is provided, wherein the apparatus is a gas sensor having a plurality of electrodes cooperating with a single electrolyte cell for detecting the presence and concentration of gaseous components of a flue gas. A voltage is generated based on the flow of ions caused by differing gas concentrations as detected by electrodes across the electrolyte. The change in voltage is correlated and is used to determine the concentration of detected gases, such as combustible gases, nitric oxides, carbon monoxide, etc., contained in the flue gas. The combustor operation may then be optimized to enhance efficiency and minimize undesired gas concentrations in the flue gas in a desired fashion. A calibration gas may be introduced to calibrate the apparatus and a reference gas may be provided to an electrode as a basis for correlating the concentrations of the gases.

### RELATED APPLICATIONS

This application is based on Provisional Application Serial No. 60/434,426, filed Dec. 19, 2002, the subject matter of which is incorporated herein by reference.

### BACKGROUND OF THE INVENTION

The invention relates to a combustion system and apparatuses for monitoring and measuring gases, such as constituent gases in flue gases. In particular, the invention relates to a probe structure for use in combustion systems and methods and apparatuses that monitor and measure gases, such as constituent gases in flue gases. Additionally, the invention relates to probe structures as part of sensors for use in monitoring and measuring of gases in combustion applications, such as, but not limited to, boilers, furnaces, combustion gas turbines or fossil combustors.

Several methods and systems have been proposed for monitoring and measuring gases in a combustion system. These methods and systems include sensors that are inserted into combustion system, such as a coal boiler environment. Such sensors are typically adequate to monitor gases, e.g., oxygen (O₂) and carbon monoxide (CO) in relatively moderate temperature ranges, i.e. less than 600° C.

Moreover, these known sensors are typically designed for a stagnant, periodic or occasional basis measurement. These sensors generally do not provide sufficient structural configuration to provide a dynamic measurement of the combustion system's gas stream, which is desirable to provide real-time and accurate sensor measurements. Further, these conventional sensor structural configurations do not provide a sensor's structural configuration that could accommodate and sense gas fluctuations in the combustion system while protecting the sensor's cell and allowing for a calibration area when calibration gas flows in the combustion system.

Furthermore, these known sensors are typically designed for use in a limited temperature range, typically not above 600° C. This temperature is often encountered at the central internal locations of a combustion system where dynamic measurements should be taken to provide accurate measurements. The conventional attempts to locate sensors at central internal locations of a combustion system often did not provide structures that could accommodate the temperatures, such as equal to or greater than 700-800° C.

A hydrocarbon fuel can be burned in a combustor or combustion system (hereinafter “combustion system”), such as, but not limited to, boilers, furnaces, combustion gas turbines or fossil combustors, to produce heat to raise the temperature of a fluid. Various governmental entities have imposed limits for combustion byproducts/products that operators of combustion systems must fall within for compliance with environmental regulations and design constraints. For the combustion system to operate efficiently and to produce an acceptably “complete” combustion (a combustion where combustion byproducts/products fall within the limits imposed by environmental regulations and design constraints), individual burners of the combustion system should be operating cleanly and efficiently. Further, post-flame combustion control systems should be properly balanced and adjusted so the combustion system operates with compliance with environmental regulations and design constraints.

Emissions of unburned carbon, nitric oxides (in this application meaning NO, NO₂, NOx), carbon monoxide or other byproducts commonly are monitored to ensure compliance with environmental regulations. As used herein and in the claims, the term nitric oxides shall include nitric oxide (NO), nitrogen dioxide (NO₂), and nitrogen oxide (NOx, where NOx is the sum of NO and NO₂). The monitoring of emissions heretofore has been done, by necessity, on the aggregate emissions from the combustion system. This monitoring has been accomplished using the entire combustion system burner array. Some emissions, such as the concentration of gaseous combustibles in hot flue gases at the central internal locations, are difficult and/or expensive to monitor on-line and continuously. These hot flue gas emissions are typically measured only on a periodic or occasional basis. When a particular combustion byproduct is found to be produced at unacceptably high concentrations, the combustor should be adjusted to restore proper operations. However, measurement of aggregate emissions, or measurement of emissions on a periodic or occasional basis, provides little, if any, useful information regarding what particular combustor parameters should be changed to effect such an adjustment.

Three main combustion variables, namely O₂, CO and NOx should be continuously monitored to optimize a combustion process and to achieve a goal of providing enhanced and near maximum efficiency at a lowest if not minimum level of emissions. Solid electrolyte (e.g., zirconia) based combustion sensors are known and commonly used in fossil combustors to measure oxygen and combustibles. These sensors are usually used with reference air applied to one of two electrodes, and are extractive and require high maintenance.

Recently some suppliers have introduced oxygen sensors that do not utilize a continuous supply of reference gas. Instead, these sensors have a sealed internal electrode filled with a mixture of metal/metal oxide that generates a constant partial pressure of 02 inside the sealed volume.

Further, Nernstian solid electrolyte sensors are known to be used in methods that measure NOx in combustion system flue gas using in a mixed potential potentiometric mode. In such Nernstian solid electrolyte sensor designs, the analyzed gas, prior to reaching a measuring electrode, passes through a porous filter. The filter is intended to enhance the Nernstian solid electrolyte sensor's sensitivity to NO or NOx, the sum of NO and NO₂. The practical use of such “filtered” NOx sensors is difficult due to the deleterious effects on other flue gas components, primarily CO and O₂.

Therefore, a need exists to provide a sensor that can be used in combustion systems at temperatures equal to or greater than 700-800° C. and primarily for sensing O₂ and CO. Furthermore, a need exists to provide a sensor structure that can accommodate and sense gas fluctuations in the combustion system while protecting the sensor's cell and allowing for a calibration area when calibration gas flows in the combustion system.

### BRIEF DESCRIPTION OF THE INVENTION

The present invention overcomes the problems noted above, and offers additional advantages, by providing an improved apparatus for monitoring gases in combustion systems. The invention may be used in a number of applications, including power boilers and fossil combustors. In one embodiment, the invention provides simultaneous monitoring and/or measuring of key combustion components, such as oxygen, NOx and CO, using one solid electrolyte-based in situ potentiometric sensor. Such sensors can be grouped together to provide necessary profiling and mapping of combustion variables as an effective tool of combustion optimization.

According to one aspect of the present invention, a fluctuational combustibles sensor provides a combined potentiometric O₂+CO sensor. In this embodiment, a reference gas (air) is supplied to one electrode (the reference electrode) of the combustibles sensor such that this reference gas flows through the sensor. This may be referred to as a flow-thru O₂+CO sensor. The O₂ component of the sensor operates like a traditional Nernstian-type sensor in that it is operated in accordance with the Nernst equation. However, the term Nernstian is often used generically to refer to sensors that are a solid electrolyte zirconia-based sensor and that do not operate in accordance with the Nernst equation. The CO and NOx aspects of the sensor are not “Nernstian” in the technical sense. Rather, the CO and NOx sensor configurations of the present invention operate in a mixed potential mode, in that the processing associated with determining concentration of CO and NOx deviates from the Nernst equation based on a number of factors, such as temperature, materials used, etc.

In one aspect, the present invention may be used to convert existing sensors or sensor designs, such as the MK CO sensor, into a combined potentiometric O₂+CO sensor. This approach offers a less complicated sensor design, where the sensor has a solid electrolyte cell with two measuring electrodes. The in situ potentiometric sensor generates an output signal which consists of two components, DC and AC. Historically, the DC component has been used to calculate O₂ using the Nernst equation and the AC component filtered out of the signal. More recently, the fluctuating AC component has been used to determine concentrations of carbon monoxide (CO), nitric oxide (NOx), or other gaseous combustibles, as described in U.S. Pat. No. 6,277,268.

When a combustor operates in the balanced-draft mode (under negative pressure), the natural draft can be used as a driving force for a reference air supply. The reference air supply line can also be used for periodic calibration of both O₂ and CO sensors by supplying calibration gases to a reference electrode.

Instead of continuous sensor heating and temperature control, the sensor is positioned in the flue gas zone at proper temperature window, for example in many boiler/furnace applications approximately between 900-1500° F.(480-815° C.) flue gas temperature. The temperature is continuously measured and used to provide compensation. The sensor head is placed inside a protective shell to facilitate its calibration, to reduce the effect of flue gas velocity and to protect its surface from ash deposits.

According to yet another aspect of the invention, the in situ solid-electrolyte sensor, as described above, is equipped with a flexible stainless hose or conduit to facilitate its packaging, assembly, installation and maintenance in a boiler. The actual gas measuring probes could be of significant length, 20-30 feet or more. When the length of the gas measuring probes is significant (exceeds 6-8 feet), the probes have to be assembled onsite, thereby complicating assembly, transportation, insertion and retraction procedures. Using the flexible hose affords greater flexibility associated with onsite installation, in conjunction with a support conduit mounted in the post-flame zone, and allows fabrication of the whole probe to take place at the factory. The unit is then shipped to the site fully assembled and the insertion and retraction of the sensor probe unit is greatly simplified, especially in congested plant environments.

Accordingly, one aspect of the present invention is to provide simultaneous and immediate measurements of several key combustion variables, such as the concentration of oxygen and other gaseous combustibles (such as CO), using one solid electrolyte-based in situ potentiometric sensor. Existing in situ, solid electrolyte potentiometric combustion sensors allow the measurement of only one combustion variable and have essential operating difficulties. A combustion sensor characterizing several key combustion variables simultaneously and immediately offers significant benefits for successful on-line combustion diagnostics and optimization.

### BRIEF DESCRIPTION OF THE DRAWINGS

FIG. 1 is an illustrative example of a boiler having solid electrolyte sensors positioned in the flue gas to produce signals indicative of levels of gaseous combustibles;

FIG. 2 is a schematic illustration of the overall sensor system;

FIG. 3 is an axial cross-sectional view of an end of a sensor;

FIGS. 4A-4D are schematic illustrations of several ways of introducing process gas into a volume adjacent the sensor cell while providing sufficient volume for calibration;

FIG. 5 is a schematic illustration of a calibration gas circuit with a thermocouple in the calibration gas passage;

FIG. 6 is a view similar to FIG. 5 illustrating radial holes for calibration gas;

FIGS. 7-12 are views similar to FIG. 6 illustrating various embodiments of the sensor;

FIG. 13 is a schematic illustration of apparatus for cleaning the sensor face; and

FIG. 14 is a fragmentary perspective view of a spring-biased electrical contact with the reference electrode.

### DETAILED DESCRIPTION OF THE INVENTION

The invention may be employed in a number of combustion applications, including power boilers and fossil combustors. In one manner, the invention provides simultaneous monitoring and/or measuring of oxygen, CO and other gaseous combustibles using one common in situ sensor operating in the potentiometric mode. Such sensors can be grouped together (for example, as an evenly spaced grid, with sensors strategically located to correspond to specific burner changes) to provide necessary profiling and mapping of combustion variables as an effective tool of combustion optimization.

A hydrocarbon fuel can be burned in a combustor or combustion system (hereinafter “combustion system”), such as, but not limited to, boilers, furnaces, combustion gas turbines or fossil combustors, to produce heat to raise the temperature of a fluid. Various regulatory and governmental entities have imposed limits for combustion byproducts/products that operators of combustion systems must fall within for compliance with environmental regulations and design constraints. For the combustion system to operate efficiently and to produce an acceptably “complete” combustion (a combustion where combustion byproducts/products fall within the limits imposed by environmental regulations and design constraints), individual burners of the combustion system should be operating cleanly and efficiently. Further, post-flame combustion control systems should be properly balanced and adjusted so the combustion system operates with compliance with environmental regulations and design constraints.

Emissions of unburned carbon, nitric oxides (NO, NO₂, NOx), carbon monoxide or other byproducts commonly are monitored to ensure compliance with environmental regulations. As used herein and in the claims, the term CO (carbon monoxide) corresponds to gaseous combustibles including CO, as well as unburned hydrocarbons and other reactive products of incomplete combustion. The monitoring of emissions heretofore has been done, by necessity, on the aggregate emissions from the combustor (i.e., the entire burner array taken as a whole). Some emissions, such as the concentration of gaseous combustibles in hot flue gases, are difficult and/or expensive to monitor on-line and continuously. These emissions are typically measured on a periodic or occasional basis. When a particular combustion byproduct is found to be produced at unacceptably high concentrations, the combustor should be adjusted to restore proper operations. However, measurement of aggregate emissions, or measurement of emissions on a periodic or occasional basis, provides little, if any, useful information regarding what particular combustor parameters should be changed to effect such an adjustment.

Two main combustion variables, namely O₂ and CO, should be continuously monitored to optimize the combustion process and to achieve a goal of providing maximum efficiency at the minimum level of emissions. Solid electrolyte (e.g., zirconia) based combustion sensors are well known and commonly used in fossil combustors to measure oxygen and combustibles (commercial suppliers include Rosemount Analytical, Ametek Thermox, and Yokogawa). These sensors are usually used with reference air applied to one of two electrodes. In most cases the existing sensors are extractive and require high maintenance.

A method for measuring flue gas combustibles (primarily CO) using solid electrolytes is based on using a fluctuating signal in an in situ potentiometric solid electrolyte cell directly positioned in the high temperature flue gas stream, as described in U.S. Pat. No. 6,277,268 (Khesin et al.), entitled “System And Method For Monitoring Gaseous Combustibles In. Fossil Combustors” (referred to herein as the '268 patent). These sensors are relatively simple in design and provide an immediate response. An example of an existing sensor in production and available on the market is the MK CO sensor manufactured by the General Electric Reuter-Stokes Company of Twinsburg, Ohio.

The '268 patent discloses, among other things, an apparatus for monitoring changes in a concentration of gas molecules of at least a first type in an environment. The apparatus includes a mass of material and first and second electrodes. The mass of material is permeable to ions formed when gas molecules of the first type are ionized. The first and second electrodes are arranged on the mass of material such that, when a concentration of the gas molecules of the first type at the first electrode is different than a concentration of the gas molecules of the first type at the second electrode, gas molecules of the first type are ionized at the first electrode to form ions which flow from the first electrode to the second electrode via the mass of material and are recombined at the second electrode to form gas molecules of the first type, thereby generating a signal between the first and second electrodes. Each of the first and second electrodes is in fluid communication with the environment.

More specifically, the '268 patent discloses a system for monitoring changes in a concentration of oxygen present in an environment, the system includes at least one Nernstian-type gas sensor. The sensor includes a mass of solid-electrolyte material and first and second electrodes. The first and second electrodes are disposed on the mass of solid-electrolyte material to generate a signal therebetween indicative of a difference between an oxygen concentration at the first electrode and an oxygen concentration at the second electrode. Each of the first and second electrodes is in fluid communication with the environment. However, the Nernstian-type gas sensor may be used to monitor the concentration of any number of gases. The mass of material included in the sensor is permeable to ions formed when gas molecules of a first type are ionized. A signal is generated between the at least first and second electrodes in response to changes in the concentration of the gas molecules of the first type in the environment. Further, the sensor may be free of a temperature control device.

The '268 patent further discloses a method for calibrating a gas sensor, the method including supplying each of a first gas having a first profile and a second gas having a second profile, which is different that the first profile, to the gas sensor in a predetermined sequence. The gas sensor or a signal analyzer associated therewith is adjusted based upon an output signal of the gas sensor to calibrate the gas sensor. An apparatus for calibrating a gas sensor includes a switching system and a sequencer. The switching system is in fluid communication with each of a first tank having a first predetermined gas profile and a second tank having a second predetermined gas profile. The sequencer causes the switching system to supply gas from each of the first and second tanks to the gas sensor in a predetermined sequence.

The instant invention provides apparatus for monitoring and measuring gases, to afford stable and efficient operation of a combustion system or combustion apparatus (hereinafter “combustion system”). The combustion system, as embodied by the invention, inclusive of the sensors for monitoring and measuring gases, is useful to achieve continuous, on-line monitoring of various combustion variables and their distribution profiles in different combustion zones. When combustion system monitoring, as embodied by the invention, is accomplished, individual burners as well as post-flame combustion controls may be adjusted to achieve enhanced relationships between the fuel and air flows, an enhanced distribution of individual air flows and reburning fuel flows, and an optimization of other boiler adjustments. These enhancements can act, either individually or in combination, to increase the efficiency of the combustor.

Use of oxygen sensors in combustion systems, (in situ) to monitor the concentration of oxygen are known. Typically, such in situ oxygen sensors employ a pair of porous metal electrodes (for example, but not limited to, platinum) disposed adjacent one another on opposite sides of a solid electrolyte element (for example, but not limited to, yttria (Y₂O₃) stabilized zirconia (ZrO₂) (YSZ)). One of the electrodes (a “reference electrode”) is typically surrounded by a gas having a predetermined oxygen concentration, and the other electrode (a “sensing electrode”) is typically exposed to the gas being monitored. In these in situ oxygen sensors, the solid electrolyte element becomes permeable to oxygen ions when heated to a sufficient temperature (for example, but not limited to, greater than about 600° C.).

In this in situ oxygen sensor, when the concentration of oxygen molecules is greater at one of the electrodes than at the other electrode, oxygen ions will migrate from one of the electrodes to the other electrode. The surfaces of the electrodes thus act as catalytic surfaces, which then enable oxygen molecules to become oxygen ions. The electron imbalance resulting from this flow of oxygen ions and the ionization/deionization occurring at the respective electrodes can generate a voltage between the electrodes. The voltage is a function of a ratio of the partial pressures of oxygen at the two electrodes, as well as a temperature of the solid electrolyte material. The voltage generated between the two electrodes is defined by the so-called “Nernst” equation, as follows:

E=(RT/4F)×Lₙ(P1/P2)+C

wherein:

E is the voltage out;

T is the absolute temperature of the sensor;

R is the Universal Gas Constant;

F is the Faraday's Constant;

P1 is the partial pressure of oxygen in the reference gas;

P2 is the partial pressure of oxygen in the monitored gas;

C is a constant for each individual sensor, and

Ln(P1/P2) is the natural logarithm of the ratio P1/P2.

The variables in the Nernst equation are E, T, P1, and P2. When the-partial pressure of oxygen in the reference gas (P1) is held constant, the signal E output by such a prior art in situ oxygen sensor is affected by: (1) changes in the partial pressure of oxygen in the measured gas P2, and (2) changes in the temperature T of the sensor. By eliminating the effect of the sensor's temperature T on the value of the voltage E, the voltage E output by such a sensor responds only to changes in the value P2. Thus, the voltage E can be used as an accurate indicator of the concentration of oxygen in the measured gas (i.e., E=f(P2)). The effect of a Nernstian-type gas sensor's temperature T on the value of the voltage E output therefrom is typically eliminated using one of two techniques.

According to one technique of using a known in situ oxygen sensor, a heater is provided within the in situ oxygen sensor, and the heater can be selectively activated to maintain the sensor at a constant temperature T. In accordance with another technique of using a known in situ oxygen sensor, a thermocouple is disposed within the sensor to measure the sensor's temperature T, and the voltage E is adjusted to compensate for changes in the temperature T. As used in this specification, the term “temperature control device” means any device, circuitry, hardware, software, or any combination thereof, that can eliminate the effect of the temperature T of a Nernstian-type gas sensor on the voltage E output thereby, using either of the two above-described techniques.

When gaseous combustibles come into contact with the catalytic electrode in Nernstian-type gas sensors that employ at least one porous catalytic electrode (such as, but not limited to, a porous platinum electrode) under proper conditions, gaseous combustibles are caused to combine chemically with oxygen in a combustion-type reaction to form non-combustible by-products. For example, and in no way limiting of the invention, two carbon monoxide molecules (2CO) may combine with one oxygen molecule (O₂) to form two carbon dioxide molecules (2CO₂) (2CO+O₂=2CO₂). Alternatively, two hydrogen molecules (2H₂) may combine with one oxygen molecule (O₂) at the electrode to form two water molecules (2H₂O)(2H₂+O₂=2H₂O).

As used in this specification, the term “gaseous combustible” refers to any gaseous molecule that is capable of being combined chemically with oxygen in a combustion-type reaction. A rise in the level of gaseous combustibles causes additional oxygen molecules near the electrode to be consumed because of chemical reactions between gaseous combustibles and oxygen at the catalytic electrode. This action decreases the concentration of oxygen at the electrode and correspondingly changes the voltage output by the sensor. Similarly, a decrease in the level of gaseous combustibles near the electrode can cause fewer oxygen molecules near the electrode to be consumed, thus increasing the concentration of oxygen at the electrode and correspondingly changing the voltage output by the sensor.

In the flue gas in the post flame zone (explained below) of a combustion system, as embodied by the invention, carbon monoxide (CO) is typically the prevalent gaseous combustible. Carbon monoxide typically accounts for more than about ninety-five percent of the gaseous combustibles present in the flue gas. Therefore, an output signal from a Nernstian-type gas sensor that is sensing the flue gas of combustor may serve as a reliable indicator of the level of CO present in the flue gas.

Generally, signals from Nernstian-type gas sensors comprise two components: (1) intensity (“the DC component”), and (2) fluctuating frequency (“the AC component”). The DC component, according to the Nernst equation, is a function of several parameters, including sensor temperature and oxygen concentration in the analyzed and reference gases. The DC component has been the component of interest in combustion systems that are employing sensors for determining O₂ concentration. A fluctuating AC component is commonly filtered from the output signal of an oxygen sensor because a fluctuating AC component is often considered to be noise. In non-in situ sensors, such as, but not limited to, extractive arrangements in which the sensor element is external to a post-flame zone area and sample flue gas is extracted and delivered to the external sensor, delays are commonly introduced and accuracy of the fluctuating AC component is significantly impaired, and may be effectively lost. Accordingly, the fluctuating AC component has been typically considered of little use in such systems.

Testing of boilers, supported by theoretical analysis, has demonstrated that the fluctuational AC component of an in situ oxygen sensor may be used as an indicator of combustion efficiency. This demonstration is discussed in at least two articles: (1) Khesin, M. J., Johnson A. J., Combustion Control: New Environmental Dimension, American Power Conference, Chicago, 1993; and (2) Khesin, M. J., Ivantotov, A. A., Fluctuations of Flue Gas Oxygen as Indicator of Combustibles, Teploenetgetika, 1978, 5, each of which is hereby incorporated herein by reference. As discussed in these articles, an output signal generated by a solid-electrolyte, in situ oxygen sensor can be used to monitor gaseous combustibles by correlating the fluctuating AC component of such a signal with gaseous combustibles.

The Nernstian phenomenon described in references (1) and (2) above can be applied in practical and useful manner in monitoring methods and systems for gases in a combustion system including the sensors, as embodied by the invention. To use the Nernstian phenomenon in combustion monitoring systems, as embodied by the invention, the sensor will be subjected to high operating temperatures, where high operating temperatures means temperatures greater than about 500-800° C. must be realized. Further, to use a sensor employing the Nernstian phenomenon in combustion monitoring systems, as embodied by the invention, the sensor and combustion monitoring system should be able to adapt to and overcome gradual reduction of the catalytic capacity of a sensor's electrodes, and the resultant inconsistency of results, and thus an uncertainty of signal processing algorithms used to obtain such results.

The instant invention overcomes these difficulties by providing an improved and more versatile sensor design, and an effective and universal system for monitoring gaseous combustibles in a combustor.

In one application of the present invention, one or more solid-electrolyte gas sensors are positioned in the flue gas flow in the post-flame zone of a combustor to measure fluctuations in the oxygen concentration of the flue gas. The fluctuations measured by these sensors may be used to calculate values which correlate with real-time levels of gaseous combustibles.

Each sensor may include, without limitation, a solid-electrolyte (e.g., YSZ) element and at least two metal, preferably porous, (e.g., platinum) electrodes associated therewith. In accordance with an aspect of the present invention, at least one of the electrodes is in fluid communication with a flue gas for monitoring constituent gas molecules in the flue gas. At least one other electrode is isolated so as not to be in direct fluid contact with the flue gas and may be supplied with a reference gas. The gas to be monitored may be for instance oxygen (O₂), CO, NOₓ, or other combustible gases. By way of example, the electrode isolated from the flue gas is supplied with a reference gas, e.g., air, and the other electrode is in communication with the flue gas. Both are connected in a system for monitoring the concentration of oxygen or determining the concentration of some other gas based on the concentration of oxygen. In this manner, when the oxygen concentration in the flue gas changes from a first level to a second level, the rate at which the oxygen concentration at the flue gas electrode changes from the first level to the second level is different than the rate, if it changes at all, at which the oxygen concentration at the isolated electrode changes from the first level to the second level. In other words, each of the electrodes may be configured and arranged so that there is a time constant associated therewith that determines how quickly the oxygen concentration level at that electrode rises or falls to a new oxygen concentration level in the flue gas and isolated reference environments.

Any of a number of different relationships involving a time constant may exist between the oxygen concentration at each electrode and the oxygen concentration in the respective environments, and the invention is not limited to any particular type of relationship. One example of a relationship between the oxygen concentration at an electrode and the oxygen concentration in the respective environment is an exponential relationship involving a time constant Tc, such as:

C_{E}=C_{C}+ΔC_{C}*(1−e^{-t/Tc}),

wherein:

C_{E} is the concentration of oxygen at the reference electrode,

C_{C} is the concentration of oxygen in the environment,

ΔC_{C} is the change in concentration of oxygen in the environment,

e is the exponential operator,

t is the time elapsed since the change in oxygen concentration occurred, and

Tc is a time constant specific to the electrode.

The electrodes are in fluid communication with their respective environments by different “degrees” when the time constants T_{C} of the two electrodes are different. The electrodes may be configured and/or arranged in any of numerous ways so that their time constants T_{C} differ from one another, and the invention is not limited to any particular technique for accomplishing the same. In various illustrative embodiments, for example, this goal may be achieved simply by employing electrodes that differ in their design, material and/or characteristics. For example, the electrodes may have different geometries, may be coated by materials having different porosities, may be coated by different materials, and/or may be coated by different amounts of a material, e.g., a porous, high-temperature epoxy.

When the electrodes are configured and arranged so as to have different time constants, a measured potential between the electrodes represents primarily the fluctuational AC component of the oxygen concentration in the measured gas, rather than representing both the AC and DC components, or primarily the DC component, as was done with the prior art sensors described above in which one of a pair of sensors was surrounded by a gas having a predetermined oxygen concentration. What constitutes a suitable difference between the time constants of the electrodes may vary from application to application, and the invention is not limited to any particular difference between the time constants. In various embodiments, for example, the time constants of the electrodes may differ from one another by some value between a few (e.g., two) milliseconds and several (e.g., ten) minutes.

It should be appreciated that the sensor configuration described herein is not limited to applications wherein the concentration of oxygen is monitored, as this sensor may also find applications in sensing the concentration of numerous other types of gases, e.g., carbon monoxide (CO), nitric oxide (NOx), etc., as well.

The output signal from an in situ oxygen sensor is fed to a signal analyzer, e.g., a programmed computer, where it is analyzed and used to generate one or more combustion parameters that are correlated with combustion conditions.

In one manner, the sensor output signals are analyzed to correlate an output range with a known gas concentration. For example, in a particular application and particular fuel, the NOx range of particular interest may be from 0-500 ppm (parts per million) NOx. From this, a response curve can be established by exposing the sensor to known quantities of NOx and mapping the measured output voltage response (such as in mVolts) with the known NOx concentration. Similarly, for a range of oxygen of 0-10%, the sensor may be exposed to known concentrations of oxygen and the resulting voltage response curve is applied in processing the signals received in the intended application. Likewise, for a CO range of 0-1000 ppm, a voltage response curve is established and applied in processing measured concentrations in intended applications. Although preferably sensors made pursuant to a given design will behave essentially the same, some adjustment or offset may be required, onsite or offsite, to “tweak” or otherwise bring a particular sensor into compliance with the design response curve.

The output signal can be processed in the frequency domain by using a frequency domain amplitude spectrum of the signal to generate an extremum function and one or more combustion parameters are calculated based upon one or more characteristics of the extremum function so generated. In another embodiment, the signal is processed in the time domain (as described below) by analyzing one or more characteristics of a time domain representation of the signal during a selected time interval. In still another embodiment, the signal is processed both in the frequency and time domains, and the results of calculations in each domain are combined to yield one or more combustion parameters. The levels of the gaseous combustibles may then be estimated using a combination of these calculated combustion parameters, along with limiting conditions which may depend, for example, on the temperature, level of oxygen, and/or combustibles in the controlled gas. These limiting conditions may, for example, be determined from the DC component of the sensor signal. It should be appreciated that this aspect of the invention relating to novel techniques for processing signal(s) from oxygen sensor(s) in the frequency and/or time domains to yield combustion parameters may be employed either with the prior art oxygen sensors described above which surround one electrode with a reference gas, with the oxygen sensors described above in which at least two electrodes are each in fluid communication with a common gaseous environment, or with any other type of sensor which generates a signal that includes a fluctuational AC component representing a concentration of a gas (e.g., oxygen) or other fluid.

When a single sensor is used, it generates a signal indicative of the level of gaseous combustibles at the particular point where the analyzed gas comes in contact with the sensor. The signal from such a single sensor may provide a sufficient amount of information to permit the operation of a small, single-burner industrial combustor to be optimized. When several sensors are inserted into the flue gas flow (e.g., across the width or in multiple rows to form a grid) of a combustor, the outputs of the sensors represent a distribution profile of the gaseous combustibles within the combustor. Such a profile can be utilized for combustor balancing and optimization. For example, individual burners and/or post-flame combustion systems can be adjusted to alter the generated profile until it reflects that optimal and balanced combustion conditions have been achieved. An understanding of (1) how the profile should appear when such optimal and balanced combustion conditions have been achieved, and (2) how individual burners and/or post-flame combustion systems affect different aspects of the profile may be obtained through empirical measurements, to be analyzed either collected manually or through automated statistical systems such as neural networks. This boiler balancing and optimization may be particularly useful for larger, multi-burner combustion systems.

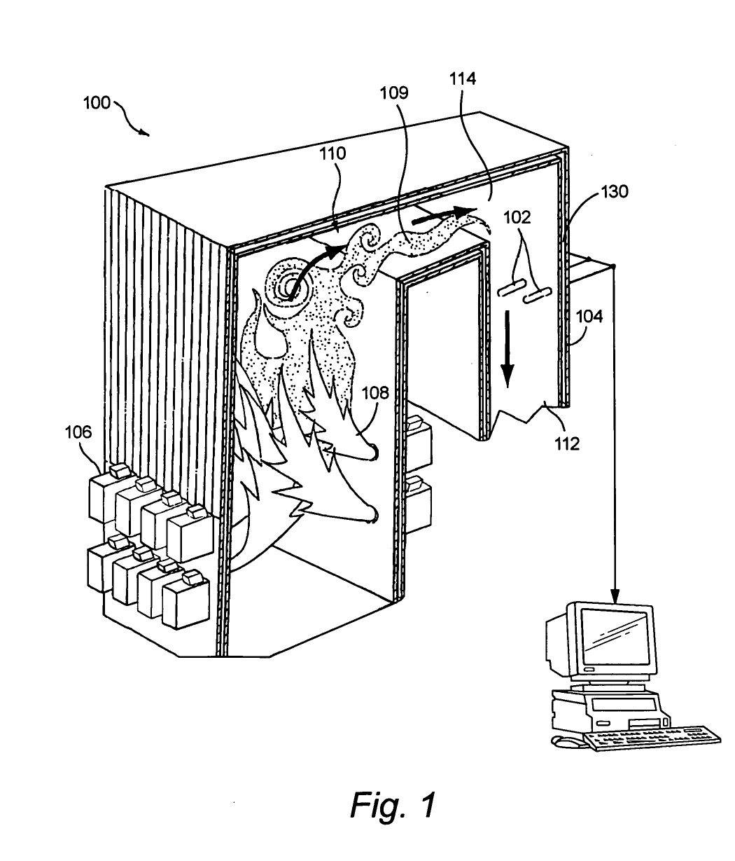

With reference to FIG. 1, there is shown a cross-sectional illustration of a combustor 100 and typical siting of several in situ oxygen sensors 102 positioned across the width of a post-flame, flue gas duct 104 of the combustor 100 to monitor the stream of hot flue gases flowing therethrough in a post-flame zone. The sensors 102 may, for example, be solid-electrolyte sensors which measure the concentration of (and/or changes in the concentration of) oxygen in the flue gases, or any other sensors capable of generating a signal indicative of the concentration of (and/or changes in the concentration of) one or more other types of gases present in the flue gases. In practice, any number of sensors 102 may be installed (preferably in a row) across the width of the flue gas duct 104. The sensors may also be arranged in a vertically-oriented row, or in a grid-like manner or other effective pattern and may extend varying depths into the duct to monitor the distribution profile of gaseous combustibles.

The combustor 100 may be more than one, two or even three hundred feet tall. As shown in FIG. 1, the combustor 100 may include a plurality of combustion devices (e.g., combustion devices 106) which mix fuel and air to generate flame in a flame envelope 108 within the combustor 100. The combustion devices may be any of numerous types of flame-producing devices, and the invention is not limited to a particular type of combustion device. According to one embodiment, for example, the combustion devices may include burners (e.g., gas-fired burners, coal-fired burners, oil-fired burners, etc.). In such an embodiment, the burners may be arranged in any manner, and the invention is not limited to any particular arrangement. For example, the burners may be situated in a wall-fired, opposite-fired, tangential-fired, or cyclone arrangement, and may be arranged to generate a plurality of distinct flames, a common fireball, or any combination thereof. Alternatively, a combustion device called a “stoker” which contains a traveling or vibrating grate may be employed to generate flame within the combustor 100.

In this specification and as claimed herein, “flame” refers to “the visible or other physical evidence of the chemical process of rapidly converting fuel and air into products of combustion,” and a “flame envelope” refers to “the confines (not necessarily visible) of an independent process converting fuel and air into products of combustion.” This meaning is consistent with the definition as set forth in a publication by the National Fire Protection Association (NFPA) of Quincy, Mass., entitled “NFPA 85C, an American National Standard,” p. 85C-11, Aug. 6, 1991.

Referring to FIG. 1, when the combustion devices 106 in the combustor 100 are actively burning fuel, two distinct locations can be identified within the combustor 100: (1) a flame envelope 108, and (2) a so-called “post-flame” zone 109, which is the zone outside of the flame envelope 108 spanning some distance toward the exit 112. Outside the flame envelope 108, hot combustion gases and combustion products may be turbulently thrust about. These hot combustion gases and products, collectively called “flue gas,” make their way away from the flame envelope 108 toward an exit 112 of the combustor 100. Water or another fluid (not shown) may flow through the walls (e.g., wall 104) of the combustor 100 where it may be heated, converted to steam, and used to generate energy, for example, to drive a turbine. In the embodiment shown, the sensors 102 are located in the post-flame zone 109 of the combustor 100. It will be appreciated, however, that the invention is not limited in this respect, and that the sensors 102 alternatively may be disposed in the flame envelope 108 if constructed to withstand the harsh, high-temperature environment thereof.

As mentioned above, in one embodiment of the invention, a voltage difference across each sensor and its reference electrodes includes a fluctuational component that may be analyzed to measure the concentrations of gaseous combustibles. The reason for this correlation is believed to be as follows. Individual burner flames comprise a multitude of eddies of various sizes inside and around the flame envelope 108. These eddies contribute to generating the familiar flame flicker at various frequencies as a result of turbulent mixing at the edges of the fuel and air jets. The eddies are transformed in the combustion process, and move in the general direction of the furnace exit 112. The overall combustion turbulence reflects the process of energy transfer from large-scale eddies to smaller and smaller eddies, down to the molecular level. The rate of the mixing process and the resulting intensity of these turbulent activities determines combustion stability and directly relates to the processes of formation and destruction of gaseous combustibles. Most of these chaotic, turbulent activities begin and occur in the flame envelope 108.

Some turbulent activities do take place in the flue gas flow of the post-flame zone 109. However, small eddies associated with combustion kinetics (i.e., small-scale, high-frequency turbulence) tend to dissipate quickly and generally do not reach the post-flame zone. Typically, only large eddies (i.e., large-scale, low frequency turbulence) are present in the post-flame zone. This low-frequency turbulence reflects combustion variables (e.g., an amount of unburned carbon and other combustibles), particularly those associated with the secondary combustion processes that are influenced by post-flame combustion control systems, such as overfire air and reburning. A turbulent stream of hot flue gases passing into the flue gas duct 114 carries products of incomplete combustion, including gaseous combustibles. As mentioned above, these gaseous combustibles travel in the turbulent flue gas flow as relatively large eddies. And such eddies, containing gaseous combustibles, should contain a very low concentration of oxygen. Each time the proper conditions occur, such as the presence of a catalyst and a high temperature (e.g., between 900 and 15000° F.) near a sensor 102, the gaseous combustibles are caused to burn and the oxygen concentration near the sensor is reduced. These fluctuations in the oxygen concentration near the sensor's electrode(s) cause pulses to be generated in the signal output by the sensor 102. The frequency and amplitude of these pulses characterizes the level of gaseous combustibles present in the analyzed flue gas flow.

The relationship between the sensor output signal and levels of gaseous combustibles may be affected by various factors, including operating combustion parameters, physical parameters, and chemical reactions. In order to more accurately monitor this multi-variable process, according to one embodiment of the invention, two or more mathematically different signal processing algorithms are employed simultaneously to analyze the signal output by the sensor, and the results of the several algorithms are combined.

Examples of methods and algorithms for processing information and signals received from gas sensors of the type described above are described, for example, in U.S. Pat. No. 6,277,268, which is hereby incorporated herein by reference in its entirety. The '268 patent discloses signal processing systems and calculations, such as conducted in the time and frequency domains, that are applicable for use with the sensor embodiments described herein. It is understood, however, that the gas sensor of the present invention is not limited to use in the processing systems described herein or in the '268 patent, but may be used in any system adapted to realize and appreciate the information obtainable from the beneficial use of the inventive gas sensor.

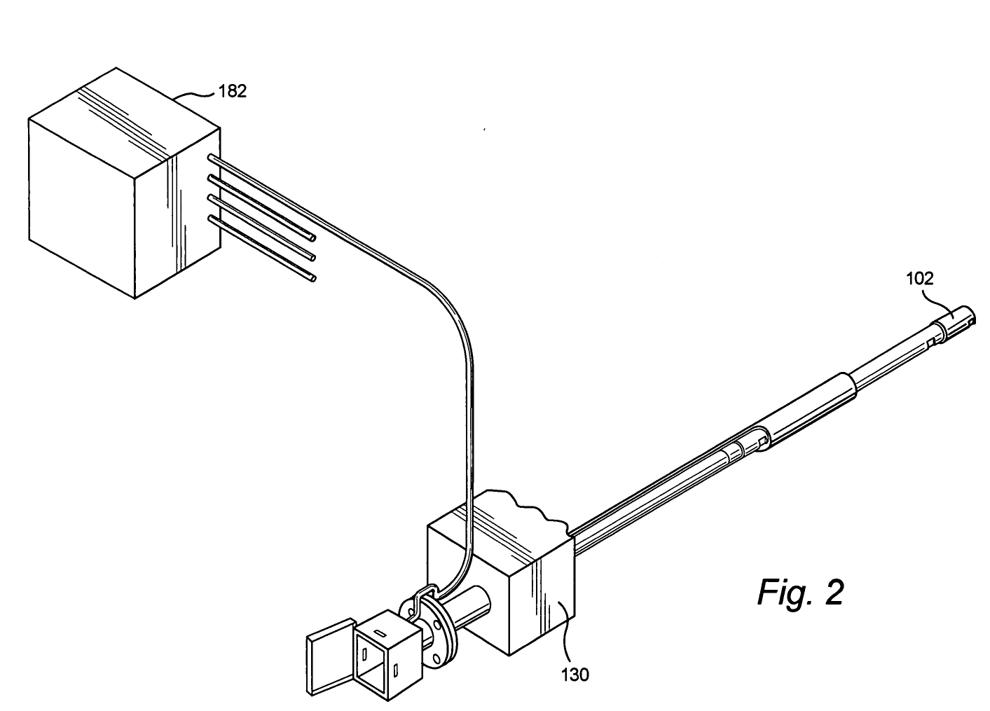

FIG. 2 shows the overall sensor system. Each sensor 102 is placed downstream of a combustion process, typically in the temperature range of 1000-1500 F. A typical installation would have a large grid of sensors for use in balancing, trimming, and optimizing the combustion process across multiple burners. The measurement end of the sensor is typically located from 4 feet to more than 30 feet into the process (i.e. distance away from the wall 130 of the boiler/combustion chamber).

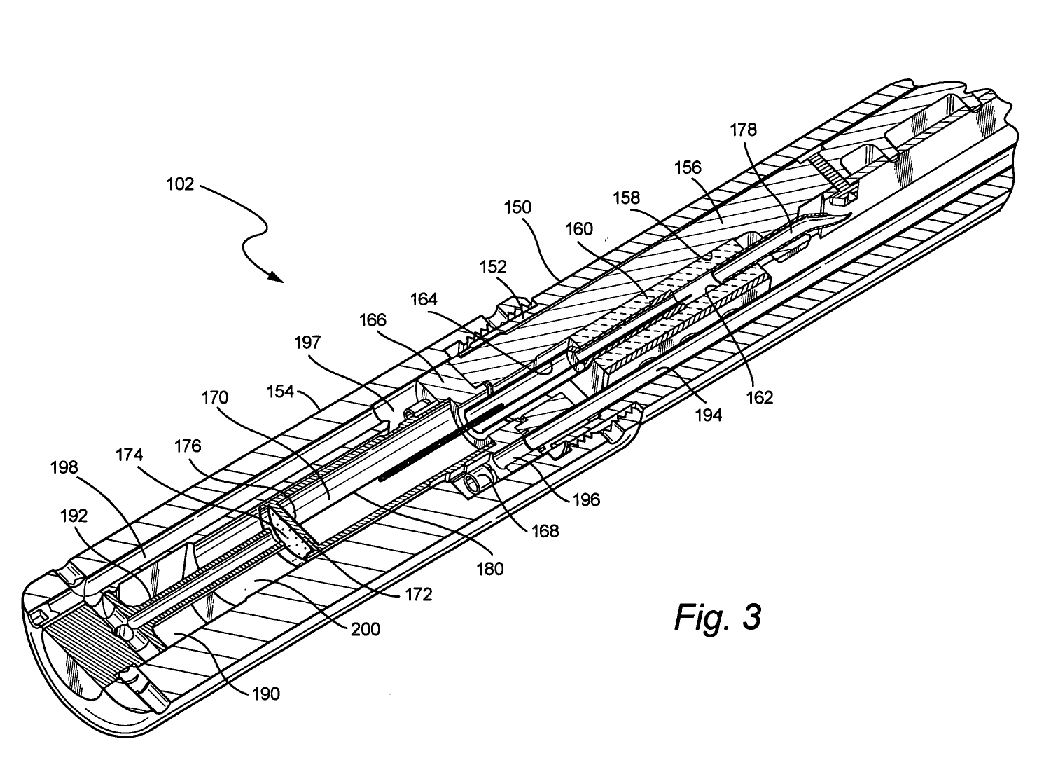

A shell 154 (FIG. 3) protects the sensor cell from the harshest aspects of the process environment, while providing the ability to calibrate. The end of each sensor 102 containing the cell can be replaced on-site, in certain embodiments described below, without cutting welds.

A solid electrolyte cell operating at high temperature (˜>500 C.) creates a voltage based on oxygen content through the Nernst principle:

$$emf \approx c + kT ln ( \frac{{P}_{{o}_{2} reference}}{{P}_{{o}_{2} process}} ) .$$

In this equation, the ratio denotes the partial pressure of oxygen at the inner (reference) and outer (process) electrodes of the measurement cell. Typically, the inner or reference electrode is designed to see a constant value of “reference air” (20.95% oxygen). Thus, the sensor 102 is designed to provide a small flow of reference air, and to maintain an adequate seal between the inside and outside of the sensor, so that the two gas flows do not communicate. A seal in the sensor maintains the process or flue gas and the reference gas from mixing—the gases leaking one side to the other would have a negative impact on sensor performance.

The voltage difference is measured between the process electrode and the reference electrode. The process electrode is usually grounded to the sensor casing. An electrical contact is made to the reference electrode and the signal lead extends all the way out of the sensor without shorting to the outside of the sensor. A number of methods of providing this contact and conducting this signal are disclosed in the various sensor embodiments disclosed herein.

Referring now to FIG. 3, the sensor 102 includes a sensor body 150 in the form of an elongated cylindrical tube, terminating in a male threaded nipple 152, to which an outer shell 154 having female threads at its proximal end is threadedly secured. Within tube 150 is a metal support structure 156 surrounding an axial opening 158. A ceramic block 160, preferably formed of an alumina ceramic, is disposed within opening 158 and includes a central passage 162. Structural support 156 also includes a central passage 164 at its distal end in communication with passage 162. An annular flange 166 is secured, for example, by bolts 168, to the end of structural support 156. Projecting from the flange 166 is a cylindrical tube 170 terminating at its distal end in a sensor cell 172. Cell 172 is formed of zirconia with platinum electrodes on opposite sides and is brazed to the cylindrical tube 170. Consequently, the outer face of the zirconia cell 172 forms the process electrode 174, while the inner face forms a reference electrode 176.

A reference gas supply tube 178 extends centrally of the sensor 102 through the passages 162 and 164 for supplying a reference gas, for example, air, within the tube 170 in contact with the reference electrode 176. It will be appreciated that the reference gas passes generally along the axis of the sensor and returns between the support structure 156, ceramic sleeve 160 and about supply tube 178. An electrical lead 180 is secured to the reference electrode 176, e.g., by brazing, and is brought back through the central passage to the controller 182 (FIG. 2). The process electrode 174 is grounded to the tube 170 and the sensor body 150. The sensor body is grounded at a flange at the boiler, which is electrically connected to the controller 182 to complete the circuit.

The sensor shell 154 comprises a cylindrical sleeve having diametrically opposed openings 190 adjacent its distal end or tip (only one opening being illustrated in FIG. 3) for receiving the flue or process gas which passes through the sensor through opposed openings 190. A calibration tube 192 extends from the tip of the sensor shell 154 toward the proximal end of the sensor, terminating short of the process electrode 174. The tube 192 lies in communication with the calibration gas supplied to the calibration tube 192 via an elongated passageway (such as a stainless steel tube) 194 through sensor body 150, an aperture 196 in flange 166, a plenum 197 and a passageway 198 along the outer shell 154 in communication with and at the distal end of the calibration tube 192. Consequently, calibration gas may be supplied through the sensor to the process electrode 174 and in a volume 200 within the sensor shell between the flue gas openings 190 and the process electrode 174. Significantly, the volume 200 is spaced back from the flow of process gas through the openings 190 sufficiently such that the calibration gas is seen by the process electrode rather than the process gas. If the flange 166 is a smaller diameter than that shown, the aperture 196 in the flange may be eliminated, and the calibration gas can flow directly from 194 to the plenum 197, going around the outside of the reduced size flange.

The sensor shell 154 serves several purposes. The shell 154 protects the cell 172 from the environment, including flow from sootblowers or direct temperature fluctuations that would potentially crack the ceramic cell 172. The outer sensor shell 154 also enables a fast variation in the gaseous constituents of the process gas to reach the sensor cell through the volume 200 to enable calculation of the gaseous combustibles (CO) parameter. The shell 154 further enables the calibration gas to be directed to the cell in a sufficient quantity, i.e., the volume 200, such that the area or volume nearest the process electrode of the cell may be flooded with calibration gas. Finally, the shell 154 enables sufficient flow of process gas for measurement purposes, while simultaneously maintaining ash and particulate matter from building up on the sensing element face. As noted below, the shell also enables a purge flow to clean the sensor face in the cell area.

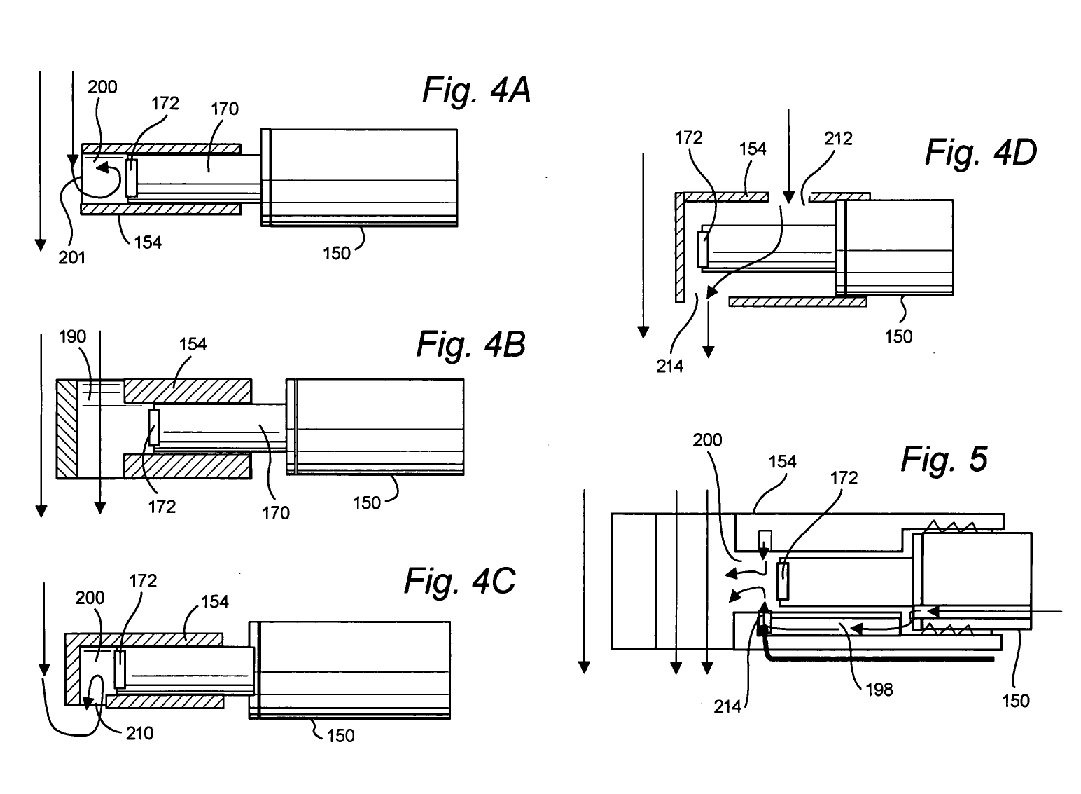

Referring to FIGS. 4A-4D, there are illustrated certain variants of the sensor. In FIG. 4A, the shell 154 is of a straight cylindrical tube design with the process gas being received in the volume 200 through a single opening 201 at the end of the shell. Opening 201 is normal to the direction of process gas flow indicated by the arrows in FIG. 4A. In FIG. 4B, the flow-through or stovepipe design previously described in FIG. 3 is illustrated. Note the openings 190 at diametrically opposite sides of the shell corresponding to the direction of flow of the process gas indicated by the arrows. In FIG. 4C, the shell 154 includes a single opening 210 located along a diameter of the shell facing the downstream direction of flow of the process gas. Thus, the process electrode 174 of cell 172 is exposed to the process gas in the volume 200 via the opening 210 to the process gas only at a diametrically downstream location. In FIG. 4D, a flow-through design is provided. In this drawing figure, the opening 212 facing the oncoming or upstream direction of process gas flow is located to one axial side of the sensor cell 172. The exit opening 214 is located on the diametrically opposite side of the shell 154 and on the axial opposite side of the sensor cell 172. It will be appreciated that in these shell design variants, the measurement cell face, i.e., the process electrode 174, is partially open to the process gas. That is, the cell 172 is not behind any thick screen, sintered metal or other filtration device. Also, various holes and passages can be formed in the shell 154 to permit ash or particulate matter to fall out of the shell. In some variants, a very thin screen or filter that does not significantly retard the dynamic process gas may be used to decrease direct impingement of ash onto the sensor cell 172.

Referring to FIGS. 3 and 5, the calibration gas circuit lying in passages 194, 196, 198 and tube 192 enables delivery of a known calibration gas to the cell 172. The calibration gas must be heated to a temperature close to the temperature of the process gas. If the sensor is long, the gas may be heated sufficiently via flow through the tube within the sensor body itself. For shorter sensors, the calibration supply tube may be external to the sensor body and include coils wrapped about the sensor body to increase the overall heat transfer area of the calibration tube. The calibration gas is blown across the face of the sensor 172, e.g., from tube 192, to ensure that the process gas is swept away from the sensor.

In FIG. 5, the passage 198 may terminate forwardly of cell 172 in discrete openings or in an annulus as described below. The passage 198 may be provided with a thermocouple 214 located near the end of the passage 198 or external to the sensor body within the zone where the calibration gas flows across the sensor face. This ensures that the temperature used to determine calibration coefficients (e.g., in the Nernst equation) is accurate. This is because the calibration gas may be at a different temperature than the process gas. In all of these configurations, the calibration gas is at sufficient velocity to force or displace the process gas from the volume 200.

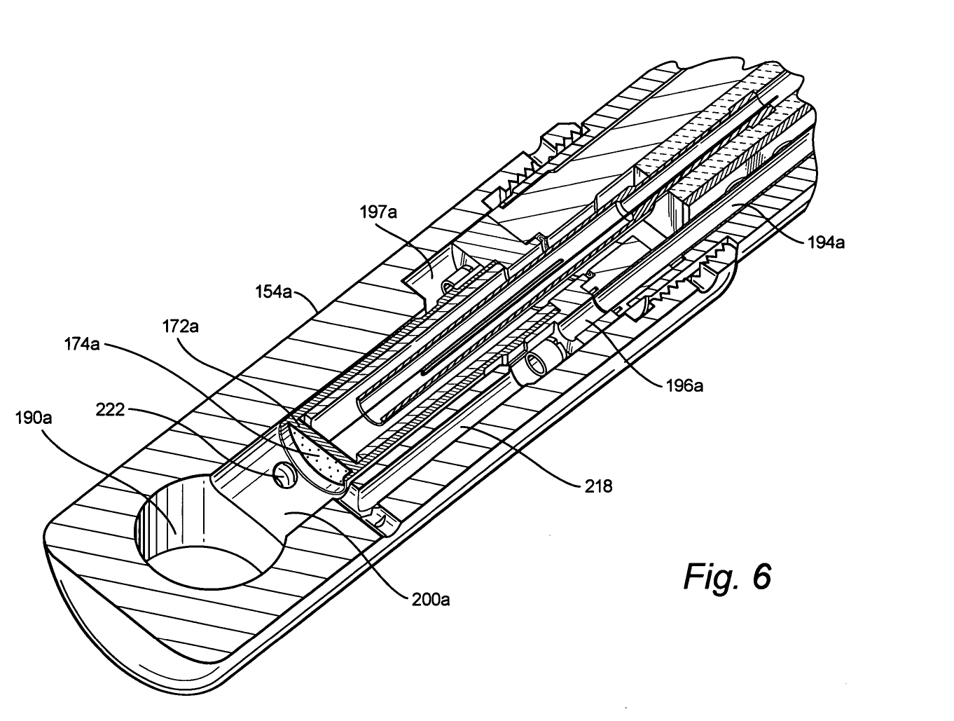

Referring to FIG. 6, there is illustrated a sensor similar to the sensor illustrated in FIG. 3, wherein like reference numerals refer to like parts, followed by the suffix “a.” In this embodiment, the calibration gas flowing through passages 194a and 196a flow also through a passageway 218 formed in the outer shell, terminating at an axial location adjacent the process electrode 174a of the cell 172a. Multiple passages 218 are provided at circumferentially spaced positions about the shell 154a in communication with the plenum 197a which receives the calibration gas from passages 194a and 196a. Radial openings 222 are provided for supplying the calibration gas in the volume 200a between the cell 172a and the process gas opening 190a. Thus, the discrete radial holes 222 supply calibration gas into the volume 200a adjacent the process electrode 174a.

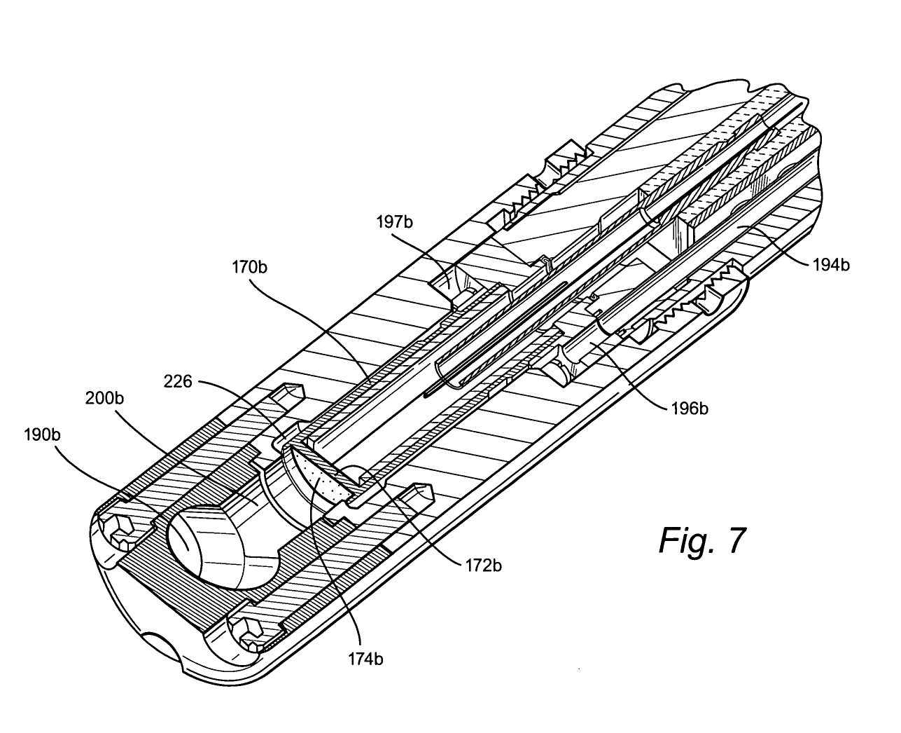

A similar arrangement is disclosed in the sensor illustrated in FIG. 7, wherein like reference numerals apply to like parts, followed by the suffix “b.” In this form of sensor, the calibration gas received in plenum 197b flows about the outside of tube 170b for communication with an annular chamber 226. The chamber 226 directs the calibration gas radially inwardly to a location in front of the sensor cell 172b in volume 200b. Thus, the calibration gas is supplied the volume 200b between the process gas opening 190b and the process electrode 174b.

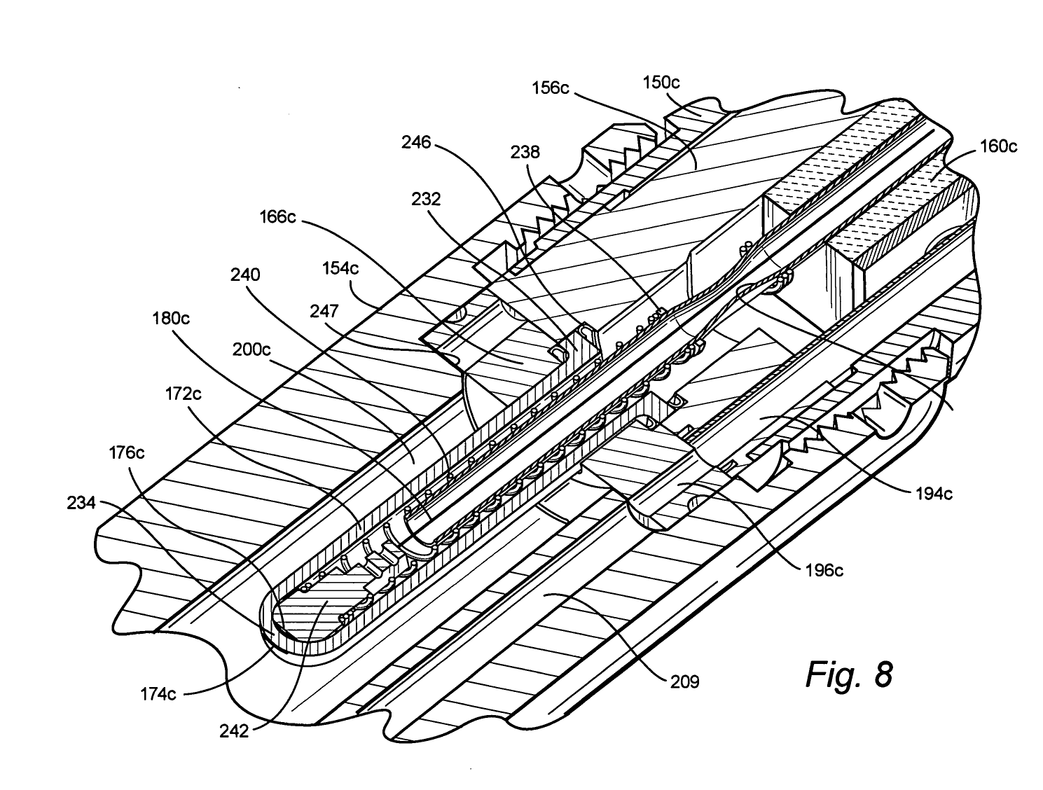

In all of the preceding embodiments of the sensor illustrated in FIGS. 3, 6 and 7, the electrical lead to the sensor comprises a wire connected, for example, by brazing, to the reference electrode 176. While this is satisfactory, it is oftentimes necessary to change out the sensor over time and it is therefore useful to provide sensors which do not require disconnection of the electrical lead and reconnection of the electrical lead which, e.g., requires brazing, upon replacement of the sensor cell. Thus, referring to the sensor of FIG. 8, wherein like reference numerals apply to like parts as in preceding embodiments, followed by the suffix “c,” a tubular sleeve 230 extends through the ceramic block 160c and through the flange 166c to terminate forwardly of the flange 166c. A thimble-shaped ceramic sensor cell 172c surrounds the forward end portion of tube 230 and terminates at its proximal end in a flange 232 and a tip 234 mounting the reference and process gas electrodes 176c and 174c, respectively. The tube 230 supplies the reference gas into the thimble-shaped sensor 172c, the return being via the annular space between tube 230 and sensor 172c and through block 160c. A retaining ring 238 is secured about tube 230 and forms a stop for one end of a helical coil spring 240. The opposite end of spring 240 bears against a metal button or element 242 movable axially within sensor cell 172c. The spring 240 bears against the element 242 to maintain the element in electrical contact with the reference electrode 176c. The electrical lead 180c is coupled to the element 242 to bring back the signal as previously indicated. Consequently, neither the element 242 nor the electrical lead 180c are physically secured to the sensor cell 172c. In FIG. 14, the electrical lead (usually made of platinum, to ensure contact without oxidation) can also be made to traverse directly through the axis of the contact element 242g and spring 240g, and end in a twist to increase contact area. The wire is pushed directly against the reference electrode by the spring. This embodiment allows easier part replacement, as the wire can be straightened and the spring and contact element slipped off, and then replaced as necessary when replacing the sensor cell itself.

In this form, the flange 166c is not bolted to the support structure 156c. Rather, the outer shell 154c includes a shoulder 247 which abuts the flange 166c. Thus, the threading action of the shell onto the tube 150c maintains the flange 166c against the support structure 156c without the necessity of bolting flange 166c to structure 156c. Also, the passages 194c and 196c and a communicating passage 209 provide for flow of calibration gas to the volume 200c in the manners previously described. Using the main body threads to provide the sealing force can be used for all embodiments of this sensor, eliminating the need for smaller bolts (168) to hold the sensor flange (166) onto the sensor housing (150).

To maintain a seal between the reference and process gases within the sensor, a pair of annular compression seals 246 lie on opposite sides of the flange 232, sealing the one side of sensor cell 172c to the support structure 156c and the opposite side of sensor cell 172c to the flange 166c. Each of seals 246 may have a “C”-shaped cross-section, be supported with an internal spring, or may be a closed “O” filled with pressurized gas. The seal may be formed of a high-tech alloy such as Alloy x-750 or proper Hastelloy grade. Note that all embodiments of the sensor can utilize at least one seal to seal the flange to the housing. In this embodiment, the braze of the sensor element (172) to its holder has been replaced with an additional seal ring. It will be appreciated that the sensor cell 172c can be readily removed and replaced without physically separating the electrical lead 180c from the sensor. Thus, the outer shell 154c can be unthreaded from the tube 150c, thereby releasing the flange 166c and the sensor 172c. The sensor 172c may then be replaced without cutting or otherwise disconnecting the electrical lead 180c. Upon replacement of a fresh sensor 172c, the element 242 is received within the sensor and the sensor is clamped between the flanges 166c and 247. The spring 240 maintains the element 242 in electrical contact with the reference electrode 176c. It will be appreciated that instead of the electrical lead 180c, the spring itself may carry the electrical signal from the element 242 back to the controller. The element 242 and spring 240 may have platinum plating for better contact and oxidation resistance. For the high temperature springs, they may be formed of alloy 188, alloy 230, nimonic 90, Rene 41 and other high temperature alloys. The springs must withstand continuous and cycling service at high temperatures, i.e., 800° C., and they must supply sufficient force to maintain electrical contact with the sensor.

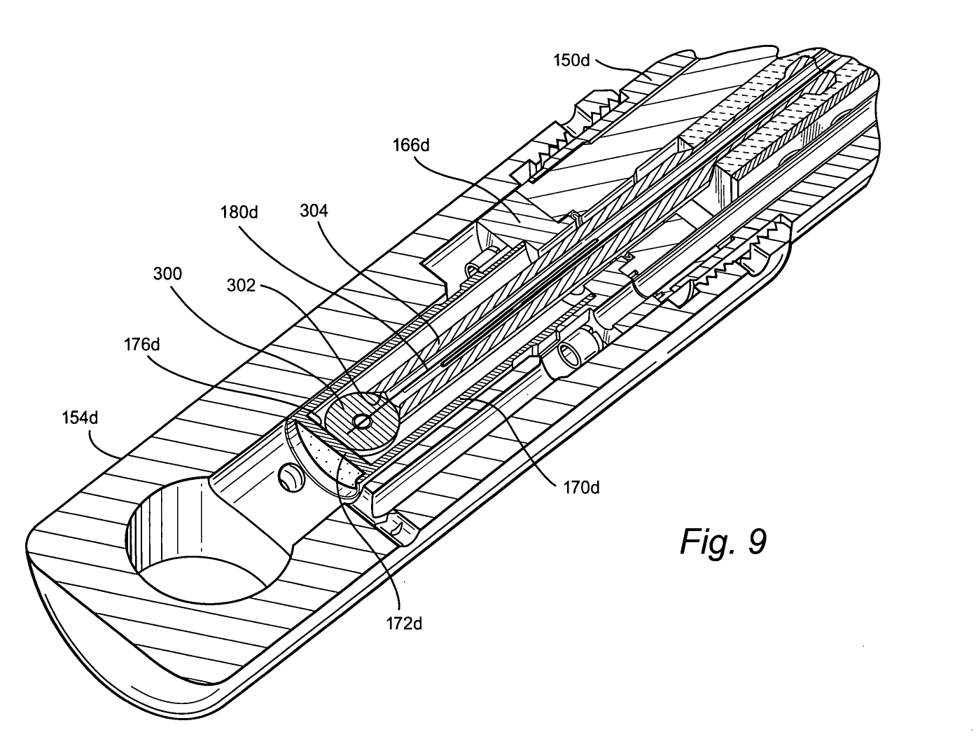

Referring now to FIG. 9, wherein like reference numerals are applied to like parts, followed by the suffix “d,” the electrical contact between the electrical lead 180d and the sensor cell 172d may be provided by a gravity ball 300. The ball 300 is electrically coupled via the electrical lead 180d to the controller 182 (FIG. 2). The ball 300 is maintained in place and in electrical contact with the reference electrode 176d by a seat 302 formed on the end of a guide tube 304 which serves to provide the reference gas, provide a channel for the electrical lead 180d and also to support the gravity ball 300. The seat 302 is shaped, for example, in a fluted, frustoconical section, and the ball cannot escape from between the reference electrode 176d and the seat 302. Consequently, in all practical orientations of the sensor, the ball 300 tends to move forwardly under gravity due to its contact with the frustoconical seat 302 and into electrical contact with the reference electrode 176d. As in the prior embodiment, the sensor shell 154d may be unthreaded from the tube 150d and the tube 170d mounting the sensor and flange 166d may be removed, enabling replacement of the sensor without disconnecting the electrical lead.

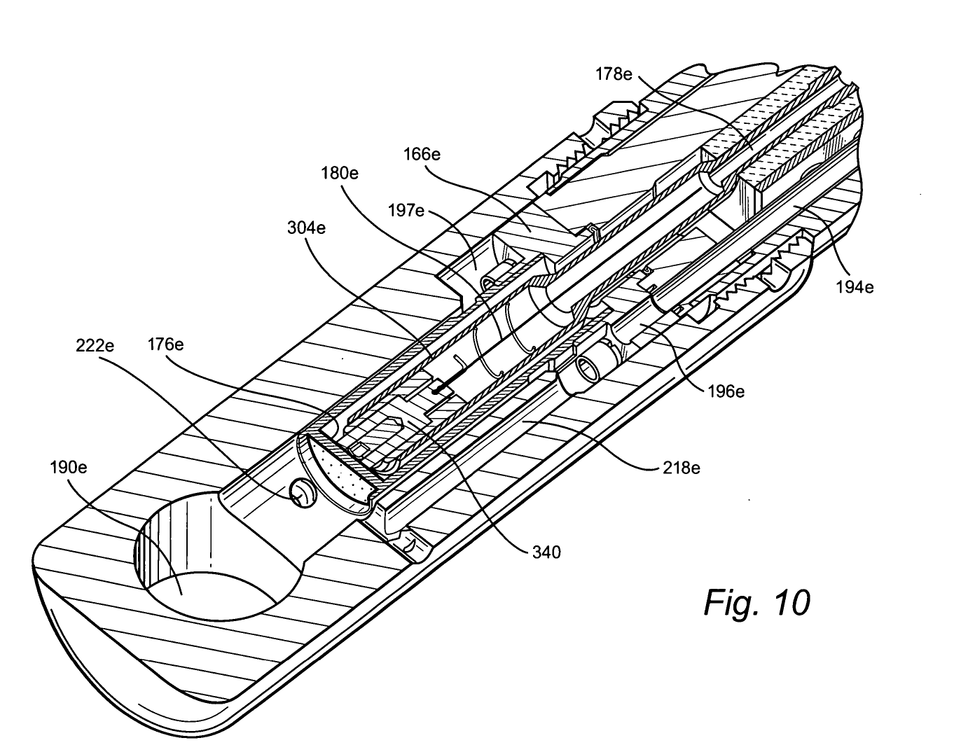

Referring now to the embodiment of FIG. 10, the electrical contact may be maintained pneumatically. Thus, in this embodiment, wherein like reference numerals refer to like parts, followed by the suffix “e,” the tube 304e carries a slidable element 340 which acts as a piston under the pressure of reference gas flowing into tube 304e via the passage 178e. The reference gas thus urges the element or piston 340 axially against the reference electrode 176e to maintain electrical contact between element 340 and electrode 176e. The electrical signal may thus be carried from the sensor via the electrical leadline 180e or via the tube 304e as desired.

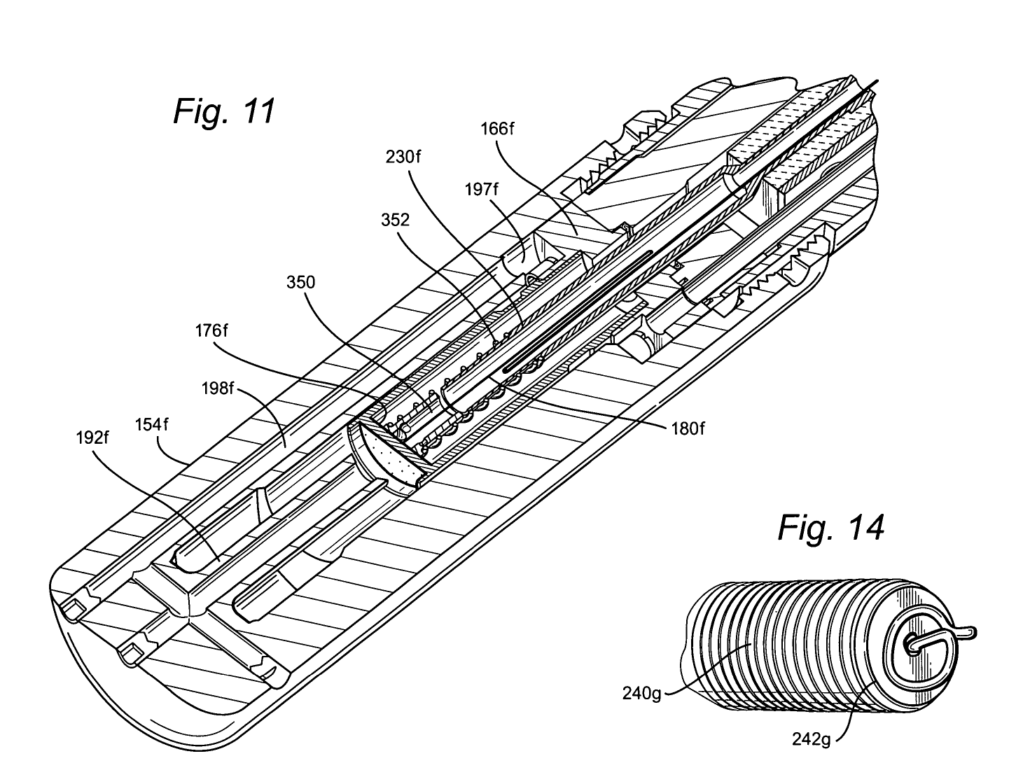

Referring to the embodiment hereof illustrated in FIG. 11, wherein like reference numerals are applied to like parts, followed by the suffix “f,” there is illustrated a sensor similar to the sensor of FIG. 3. In this form, however, the electrical contact between the reference electrode 176f and the electrical lead 180f carrying the signal to the controller 182 is maintained by a spring-loaded plug 350. Spring 352 engages between a shoulder on a tube 230f and a flange at the base of the plug 350. The tube 230f prevents the spring from buckling and keeps the wire 180f from shorting with the sides or interfering with the coils of the spring. This tube is electrically “live” and thus must be held into place by a ceramic piece, such as the block (160). Consequently, the spring 352 maintains the plug 350 in electrical contact with the reference electrode in a manner enabling the removal of the sensor and its replacement without disconnecting the electrode.

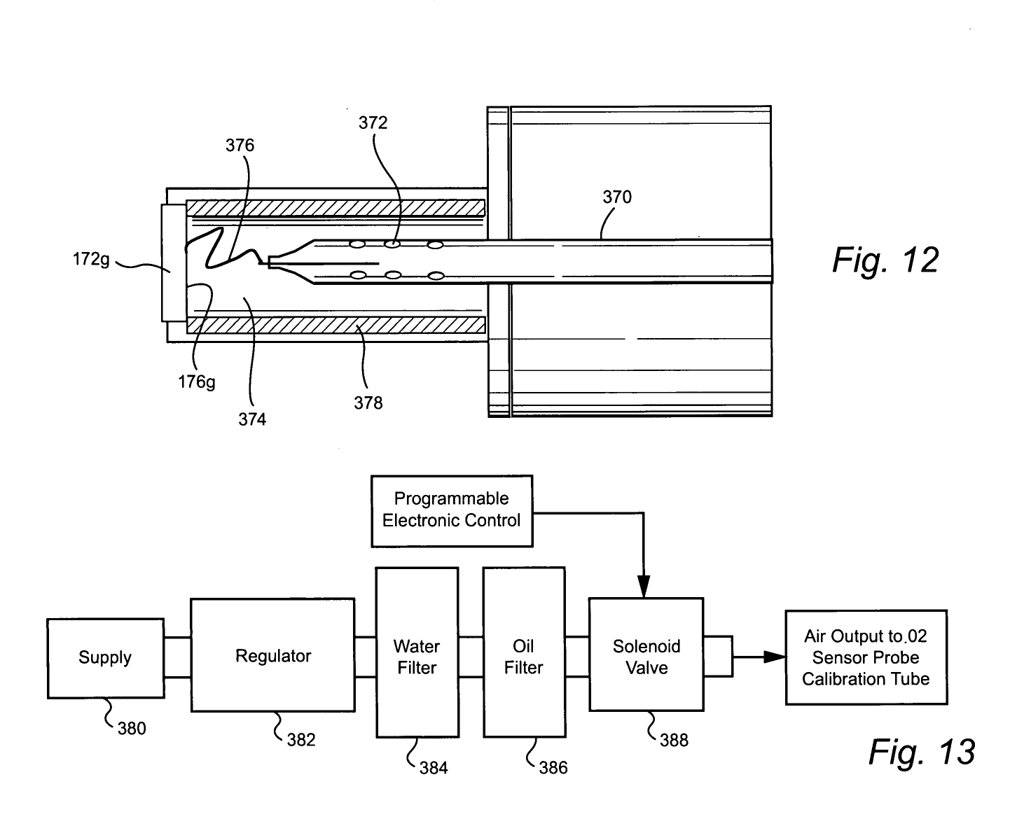

Referring now to FIG. 12, there is illustrated a portion of a sensor similar to prior embodiments wherein like reference numerals apply to like parts, followed by the suffix “g.” Here, the reference gas tube 370 has apertures 372 for supplying reference gas into the region 374 behind the sensor 172g and the reference electrode 176g. Electrical contact is made with the reference electrode 176g by a wire 376 bonded thereto. The opposite end of the wire 376 is pinched or crimped in place on the reference air tube 370. To replace the sensor cell, the end of the reference air tube 370 is snipped off and a new sensor end is fitted onto the end. The wire 376 is placed inside the air tube and crimped into place. When the end is brought into a bolting position and into final securement, the wire outside tube 370 would bunch up and, accordingly, a ceramic sleeve 378 surrounds the tube 370 to prevent the wire from shorting out.

The value of monitoring concentration of combustible gases is also a measure of combustion instability. The methodology for calculating CO (or combustible gases) is provided in the following ways.

The measurement of combustible gases is a function of the AC voltage of the cell:

CO=f(AC voltage from cell)

Where CO stands for the measurement of combustible gases.

In this extension, the algorithm can be expressed as the more generic function

CO=f(O₂variation,T_{cell},R,O₂,FM,Shell)

Where:

O₂ variation=a measure of the time-dependent (AC rather than DC) variability of the Oxygen (or mV signal) coming from the cell.

T_{cell}=the temperature of the cell.

R=responsiveness factor for the cell, e.g. a T₉₀ value measured in the laboratory

FM=a factor for the furnace fluid mechanics, perhaps to reflect the typical eddy size reaching the sensor

Shell=a factor accounting for the design of the shell that protects the sensing electrode. For example, a shell that exposes more of the measuring cell to the process fluid would generally see a higher level of O₂ variations than one that is more protective of the measuring cell.

The actual functional relationship calculation of CO in this relationship can be described by a multitude of methods, all of which use the variability (AC signal) of the cell voltage (or O₂ variability) as a key input into the calculation.

The functional relationship of the calculated CO to the variables can be explicit, such as:

CO=f₁(O₂variation)*f₂(T_{cell})*f₃(R)*f₄(O₂)*f₅(FM)*f₆(Shell)

The functional relationship can also be implicit, as for example, if it were calculated using a statistical approach, such as with a trained neural net.

CO Calibration—Calculation

Calibration method 1—The first calibration for CO for a sensor in the field can be made by comparing with extracted data and changing model parameters so that the calculated CO matches the extracted CO value. However, subsequent changes in calibration settings can be made through the in-field calibration for O₂. That is, the sensor relationship for T, FM, and Shell and O₂ variation do not change, whereas the functions for R, and O₂ can be calculated by flowing calibration gas, as is done during the calibration for oxygen.

Calibration method 2—In a laboratory, the oxygen content is varied at a periodic frequency between 2 values, such as 3% and 0.5% with background inert gas (such as N₂). The value for CO (calculated using a standard algorithm) for those conditions is compared with a value of CO that is expected to be calculated for those conditions. The calibration coefficient(s) are then altered such that the calculation would then match the standard expected value.

Calibration method 3—The first calibration for CO for a sensor in the field can be made by comparing with extracted data and changing model parameters so that the calculated CO matches the extracted CO value. Shortly after this initial calibration, calibration gas is flowed into the sensor, where the oxygen content is varied between 2 values, such as 3% and 0.5% with background inert gas (such as N₂). The calculated value for CO out of the sensor based on that variation is recorded (as CO_A). At a later date, when the CO sensor is to be recalibrated, the calibration gas is flowed into the sensor, where the oxygen content is again varied in the same manner. The calculated value for CO based on this variation is recorded (as CO_B). The ratio of these two values, (CO_A/CO_B) is used in the CO calculation algorithm to shift up (or down) the calculations.

O₂ Calibration—Calculation

The method of calibrating an oxygen sensor is to flow a ‘low’ oxygen calibration gas (such as 1% or 3% oxygen with background Nitrogen), measure the voltage and temperature, and then flow a ‘high’ calibration gas (such as 8%, 10% or instrument air—20.95%), and measure the voltage and cell temperature. These two values are used to fit the constants in the Nernst equation. This is one option for calibration of the sensor.

An alternative method is to flow calibration gas on the reference gas side rather than the process gas side. The calibration gas on this side would include 1) instrument air, 2) gas with a low value of oxygen, close to the process value (−5% oxygen) and 3) air with very high oxygen content (higher than 20.95% most likely near 60%). Assuming that the process gas concentration does not change dramatically during this period, the two Nernst equation constants would then be fit using the voltages measured from flowing these three different reference gases. Using some simplifications, it may also be possible to calculate the calibration coefficients by flowing only 2 of the three gases mentioned above.

Use of this method would circumvent the need for sufficient volume in front of the sensor face (measurement electrode) within the shell design.

Another alternative method is to calibrate to extracted oxygen sensor measurements. The extracted gas would flow through either the internal calibration tube, normally used for flowing calibration gases to the sensor head, or from an additional tube, located externally or internally to the sensor body, which is used primarily for the purpose of extracting flow from near the sensor head.

It will be appreciated that in situ sensors such as previously described used in harsh environments such as boilers are subject to deposition of ash and other chemical substances on the sensing element, i.e., the sensor cell 172. Such depositions isolate the sensing element from the process gas and thus prevent the sensor from properly measuring the gas. In the present oxygen/carbon monoxide indicator probes, the calculations of gaseous combustibles depends on reading the fast fluctuations of the process gas via a Nernstian ceramic electrode sensor. These types of sensors cannot utilize thick mechanical filters to protect the sensor because the filters dampen the fluctuation. The present invention therefore affords automatic circuitry and a delivery mechanism to periodically flow air or other gas at or across the sensing element of the sensor to remove deposits of ash or other debris or chemical buildup, enabling the sensor to function properly over long periods of time.

Referring now to FIG. 13, there is illustrated schematically an air/gas circuit having an outlet directed at the face of the sensor, i.e., the process electrode 174. As illustrated in FIG. 13, a supply 380 of compressed gas is derived from a source of compressed gas, for example, “house air” at a power plant. The air supply flows through a regulator 382, is filtered by water and oil filters 384 and 386, respectively, and passes through a solenoid valve 388. The valve 388 is controlled by an electronic module forming part of the controller 182 of the sensing system. The electronics module sends a signal to open the valve on a periodic basis to enable the compressed gas to clean the sensor face.

The supply line of the compressed gas through the sensor 102 may be provided by the calibration gas lines. For example, referring to FIG. 3, the compressed gas may flow through the existing calibration line comprised of passages 194, 196, plenum 197, passage 198 and tube 192. Thus, the solenoid may be periodically opened to supply the gas to clean the sensor face, i.e., the process electrode 174, of ash and other undesirable substances. In especially severe environments, the electronic module can provide a continuous flow of gas to clean the sensor face and turn off the flow only when a reading is desired and, in this manner, the gas is provided almost continuously to maintain the sensor element clean. It will be appreciated that the cleaning gas is provided across the sensor face, for example, by discrete radial passages (FIGS. 6, 9 and 10) or through the annular passage (FIG. 7) or can be directed normal to the sensor surface (FIG. 3) or to provide a swirl around the sensor face, or combinations thereof.

It will also be appreciated that the compressed gas can be provided to the sensor face in a separate line apart from the calibration gas line. Thus, a separate flow line can be provided in the sensor, terminating in discrete radial ports, the annular port, or a single or multiple axial ports directed to flow the cleaning gas across the sensor face.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A sensor for monitoring a level of gaseous combustibles in a combustor which supplies process gas into the environment, the sensor comprising:
a sensor body having an outer shell surrounding a sensor cell;
said sensor cell including reference and process gas electrodes on opposite sides thereof for generating a signal therebetween indicative of a difference between oxygen concentrations at the reference and process gas electrodes, respectively;
said sensor body carrying electrical leads coupled to said reference electrode and said process electrode for carrying the electrical signal to a signal analyzer;
said shell having an opening for receiving the process gas for contact with the process electrode;
said process electrode being spaced from said process gas opening to define a volume within the sensor body out of direct line of sight from the flow direction of the flue gas; and
a passage within the sensor body in communication with said volume for directing calibration gas to said volume such that sufficient calibration gas is provided the volume to enable calibration of the sensor.

2. A sensor according to claim 1 wherein said sensor body is elongated about an axis and said sensor cell lies generally perpendicular to said axis, said calibration gas passage including a passageway having an outlet for flowing calibration gas in an axial direction generally away from a distal tip of the sensor.

3. A sensor according to claim 2 wherein said passageway extends from adjacent the distal tip of the sensor axially across said process gas opening to terminate in said volume.

4. A sensor according to claim 1 wherein said sensor body is elongated about an axis and said sensor cell lies generally perpendicular to said axis, said calibration gas passage including at least one passageway having an outlet port for directing calibration gas in a generally radial inward direction on a side of said process electrode exposed to said volume.

5. A sensor according to claim 1 wherein said sensor body is elongated about an axis and said sensor cell lies generally perpendicular to said axis, said calibration gas passage including an annulus about said sensor cell opening radially inwardly for directing calibration gas in a generally radial inward direction and on a side of said process electrode exposed to said volume.

6. A sensor according to claim 1 wherein said calibration gas passage includes a thermocouple adjacent said volume.

7. A sensor according to claim 1 wherein said electrical lead coupled to said reference electrode includes an electrical lead wire secured to said reference electrode.

8. A sensor according to claim 1 wherein said sensor body is elongated about an axis and said sensor cell lies generally perpendicular to said axis, said electrical lead coupled to said reference electrode including an electrically conductive element, and a spring carried by said sensor body for biasing said element in an axial direction into electrical contact with said reference electrode.

9. A sensor according to claim 1 wherein said sensor body is elongated about an axis and said sensor cell lies generally perpendicular to said axis, said sensor body including a seat having a surface of revolution, said electrical lead coupled to said reference electrode including a ball having an electrical contact and engaged between said surface of revolution and said reference electrode, enabling the ball to maintain the contact of the ball in electrical contact with the reference electrode.

10. A sensor according to claim 1 wherein said sensor body is elongated about an axis and said sensor cell lies generally perpendicular to said axis, said body including an axially movable element forming part of said electrical lead coupled to said reference electrode, said body including a passage for flowing a reference gas in an axial direction against said axially movable element to maintain electrical contact between said reference electrode and said element.

11. A sensor according to claim 1 wherein said sensor body is elongated about an axis and said sensor cell lies generally perpendicular to said axis, said sensor cell being mounted at a closed end of an axial tube with the reference electrode on the inside face of the closed end, an electrical contact element movable axially within said tube and a spring for biasing said element into electrical contact with said reference electrode.

12. A sensor according to claim 11 wherein said tube terminates adjacent its opposite end in a flange and at least one seal between said sensor body and said flange for maintaining the reference gas supplied within the tube separate from the process gas within the sensor.

13. A sensor according to claim 1 wherein said sensor body includes a channel terminating adjacent said process electrode, a source of compressed gas and a valve for controlling the flow of compressed gas through said channel for periodically cleaning the face of the process electrode.

14. A sensor according to claim 1 including means for flowing a cleaning gas across the process electrode to maintain the process electrode substantially clear of contaminants affecting the monitoring of the gaseous combustibles.

15. A sensor for monitoring a level of gaseous combustibles in a combustor which supplies process gas into the environment, the sensor comprising:
a sensor body having an outer shell surrounding a sensor cell;
said sensor cell including reference and process gas electrodes on opposite sides thereof for generating a signal therebetween indicative of a difference between oxygen concentrations at the reference and process gas electrodes, respectively;
said sensor body carrying electrical leads coupled to said reference electrode and said process electrode for carrying the electrical signal to a signal analyzer;
said sensor body being elongated about an axis and said sensor cell lying generally perpendicular to said axis, said electrical lead coupled to said reference electrode including through an electrically conductive element, and means carried by said sensor body for biasing said element in an axial direction into electrical contact with said reference electrode.

16. A sensor according to claim 15 wherein said biasing means includes a spring.

17. A sensor according to claim 15 wherein said biasing means includes a seat having a surface of revolution, said electrical lead coupled to said reference electrode including a ball having an electrical contact and engaged between said surface of revolution and said reference electrode, enabling the ball to maintain the contact of the ball in electrical contact with the reference electrode.

18. A sensor according to claim 15 wherein said body includes a passage for flowing a reference gas in an axial direction against said axially movable element to maintain electrical contact between said reference electrode and said element.

19. A sensor according to claim 15 wherein said sensor cell is mounted at a closed end of an axial tube with the reference electrode on the inside face of the closed end, an electrical contact element movable axially within said tube and a spring for biasing said element into electrical contact with said reference electrode.

20. A sensor according to claim 15 including means for flowing a cleaning gas across the process electrode to maintain the process electrode substantially clear of contaminants affecting the monitoring of the gaseous combustibles.
